(19) United States
(12) Patent Application Publication
(10) Pub. No.: US 2026/0234774 A1
(43) Pub. Date: Aug. 13, 2026

(54) HOT ROLLED AND STEEL SHEET AND A METHOD OF MANUFACTURING THEREOF

(71) Applicant: ArcelorMittal, Luxembourg (LU)

(72) Inventors: Sanjiv SONI, Stoney Creek, Ontario (CA); Eugen Andrei IANOS, Burlington, Ontario (CA); Yaping LU, Hamilton, Ontario (CA); Jeff GAO, Burlington, Ontario (CA)

(21) Appl. No.: 19/153,615

(22) PCT Filed: Feb. 8, 2023
(86) PCT No.: PCT/IB2023/051115

§ 371 Date: Aug. 5, 2025

(51) Int. Cl. C22C 38/38; C21D 8/0221; C22C 38/00; C22C 38/02; C22C 38/04; C22C 38/06; C22C 38/22; C22C 38/24

(52) U.S. Cl. CPC C22C 38/38; C21D 8/0226; C22C 38/002; C22C 38/02; C22C 38/04; C22C 38/06; C22C 38/22; C22C 38/24; C21D 2211/009

(57) ABSTRACT

A hot rolled steel sheet having a composition including the elements, 0.09%≤Carbon≤0.15%, 1%≤Manganese≤2%, 0.1%≤Silicon≤0.5%, 0.01%≤Aluminum≤0.1%, 0.3%≤Chromium≤1%, 0.1%≤Molybdenum 0.5%, 0.05%≤Vanadium≤0.14%, 0.002%≤Phosphorus≤0.02%, 0%≤Sulfur≤0.005%, 0%≤Nitrogen≤0.01%, 0%≤Niobium≤0.09%, 0%≤Titanium≤0.09%, 0%≤Calcium≤0.005%, 0%≤Copper≤1%, 0%≤Nickel≤1%, 0%≤Boron≤0.05%, 0%≤Magnesium≤0.05%, 0%≤Zirconium≤0.05%, 0%≤Cerium≤0.1%, the remainder composition being composed of iron and unavoidable impurities caused by processing, the microstructure of the steel sheet including in area fraction, 50% to 93% of Bainite, 5% to 50% of ferrite, 1% to 15% of Martensite-Austenite islands, 1% to 15% Pearlite.

The present invention relates to hot rolled steel sheets suitable for use as steel sheet for automobiles.

### BACKGROUND

Automotive parts are required to satisfy two inconsistent necessities, namely ease of forming and strength. However, in recent years a third requirement of improvement in fuel consumption is also bestowed upon automobiles in view of global environment concerns. Thus, now automotive parts must be made of material having high formability in order to fit in the criteria of ease of fit in the intricate automobile assembly and at same time improve strength for vehicle crashworthiness and durability while reducing weight of vehicle to improve fuel efficiency.

### SUMMARY OF THE INVENTION

Intense research and development endeavors have been undertaken to reduce the amount of material utilized in vehicles by increasing the strength of material. Conversely, an increase in strength of steel sheets decreases formability, and thus the development of materials having both high strength and high formability is necessitated.

Earlier research and developments in the field of high strength and high formability steel sheets have resulted in several methods for producing high strength and high formability steel sheets, some of which are enumerated herein for conclusive appreciation of the present invention:

CN113201691 discloses a 590 MPa-level hot rolled steel plate for hydraulic bulging and a preparation method thereof, and belongs to the technical field of steel material engineering. The 590 MPa-grade hot rolled steel plate for hydraulic bulging comprises the following chemical components in percentage by weight: 0.02-0.04% of C, less than or equal to 0.05% of Si, 1.05-1.15% of Mn, 0.040-0.050% of Nb0.050%, 0.050-0.060% of Ti, 0.30-0.60% of Cr0.02%, less than or equal to 0.02% of P, less than or equal to 0.003% of S, less than or equal to 0.0040% of N, 0.010-0.050% of Als, 0.0010-0.0050% of Ca, and the balance of Fe and inevitable impurities. The invention adopts a micro/low C—Nb—Ti—Cr microalloying component system and obtains the microstructure of ultrafine grained acicular ferrite and a nano precipitated phase by a controlled rolling and controlled cooling process technology. The mechanical properties of the steel plate provided by the invention meet the following requirements: The yield strength is more than or equal to 500 MPa, the tensile strength is more than or equal to 590 MPa, the elongation is more than or equal to 25 percent, the n value is more than or equal to 0.12, the d-a is qualified in a 180-degree cold bending test, and the grain size is more than or equal to 12 grade, so that the problem of poor forming performance of the existing high-strength steel can be effectively solved. However, CN113201691 does not exhibit homogenous properties in all three directions that are transversal direction and longitudinal direction, therefore limits its usage in the automotive industry.

It is an object of the present invention to solve these problems by making available hot-rolled steel sheets that simultaneously have:
an ultimate tensile strength greater than or equal to 770 MPa in both transversal direction and longitudinal direction preferably greater than or equal to 800 MPa in both transversal direction and longitudinal direction,
a yield strength greater than or equal to 650 MPa in both transversal direction and longitudinal direction preferably a yield strength greater than or equal to 680 MPa in both transversal direction and longitudinal direction,
a total elongation greater than or equal to 14% in both transversal direction and longitudinal direction preferably a total elongation greater than or equal to 15% in both transversal direction and longitudinal direction, and
a hole expansion ratio of greater than or equal to 50% and preferably greater than or equal to 60%.

In a preferred embodiment, the steel sheets according to the invention may also present a yield strength to tensile strength ratio of 0.5 or more.

Preferably, such steel can also have a good suitability for forming, in particular for rolling with good weldability and coatability.

The present invention provides a hot rolled steel sheet having a composition comprising of the following elements, expressed in percentage by weight:

$$0.09 \% \leq Carbon \leq 0.15 \%$$

$$1 \% \leq Manganese \leq 2 \%$$

$$0.1 \% \leq Silicon \leq 0.5 \%$$

$$0.01 \% \leq Aluminum \leq 0.1 \%$$

$$0.3 \% \leq Chromium \leq 1 \%$$

$$0.1 \% \leq Molybdenum \leq 0.5 \%$$

$$0.05 \% \leq Vanadium \leq 0.14 \%$$

$$0.002 \% \leq Phosphorus \leq 0.02 \%$$

$$0 \% \leq Sulfer \leq 0.005 \%$$

$$0 \% \leq Nitrogen \leq 0.01 \%$$

and can contain one or more of the following optional elements

$$0 \% \leq Niobium \leq 0.09 \%$$

$$0 \% \leq Titanium \leq 0.09 \%$$

$$0 \% \leq Calcium \leq 0.005 \%$$

$$0 \% \leq Copper \leq 1 \%$$

$$0 \% \leq Nickel \leq 1 \%$$

$$0 \% \leq Boron \leq 0.05 \%$$

$$0 \% \leq Magnesium \leq 0.05 \%$$

$$0 \% \leq Zirconium \leq 0.05 \%$$

$$0 \% \leq Cerium \leq 0.1 \%$$

the remainder composition being composed of iron and unavoidable impurities caused by processing, the microstructure of said steel sheet comprising in area fraction, 50% to 93% of Bainite, 5% to 50% of ferrite, 1% to 15% of Martensite-Austenite islands, 1% to 15% Pearlite.

Another object of the present invention is to make available a method for the manufacturing of these sheets that is compatible with conventional industrial applications while being robust towards manufacturing parameters shifts.

The present invention provides also a method of production of a hot rolled steel sheet comprising the following successive steps:
providing a steel composition as described above;
reheating said semi-finished product to a temperature from 1200° C. to 1300° C.;
rolling the said semi-finished product in the austenitic range wherein the hot rolling finishing temperature shall be from 850° C. to 975° C. to obtain a hot rolled steel strip;
then cooling the said hot rolled strip is cooled wherein the cooling starts immediately after the finishing of hot rolling;
then the hot rolled strip is cooled from finishing of hot rolling to a cooling stop temperature range which is from 480° C. to 600° C. at a cooling rate greater than 20° C./s;
thereafter coiling the hot rolled strip at the coiling temperature range 480° C. to 600° C.; and
then cooling the coiled hot rolled strip to room temperature to obtain a hot rolled steel sheet.

The hot rolled steel sheet of the present invention may optionally be coated with zinc or zinc alloys, to improve its corrosion resistance.

### DETAILED DESCRIPTION

Carbon is present in the steel from 0.09% to 0.15%. Carbon is an element necessary for imparting the mechanical properties to the steel of the present invention by facilitating the formation of ferrite and carbon also imparts the steel with strength by precipitate strengthening by forming Vanadium Carbide or Niobium Carbides, therefore, Carbon plays a pivotal role in increasing the strength. But Carbon content less than 0.09% will not be able to impart the tensile strength to the steel of the present invention. On the other hand, at a Carbon content exceeding 0.15%, the steel exhibits poor spot weldability which limits its application for the automotive parts. A preferable content for the present invention may be kept from 0.1% to 0.14% and more preferably from 0.11% to 0.135%.

Manganese content of the steel of the present invention is from 1% to 2%. This element is gammagenous and also influences Bs and Ms temperatures, therefore plays an important role in controlling the bainite formation. The purpose of adding Manganese is essentially to impart hardenability to the steel. An amount of at least 1% by weight of Manganese has been found in order to provide the strength and hardenability to the steel sheet. But when Manganese content is more than 2% it produces adverse effects such as it retards transformation of Austenite during the cooling after hot rolling. In addition, the Manganese content of above 2% promotes the central segregation hence reduces the formability and also deteriorates the weldability of the present steel. A preferable content for the present invention may be kept from 1.3% to 1.9% and more preferably from 1.4% to 1.7%.

Silicon content of the steel of the present invention is from 0.1% to 0.5%. Silicon is a solid solution strengthener especially for microstructures Bainite. In addition, a higher content of Silicon can retard the precipitation of Cementite. However, disproportionate content of Silicon leads to a problem such as surface defects like tiger strips which adversely affects the coatability of the steel of the present invention. Therefore, the concentration is controlled within an upper limit of 0.5%. A preferable content for the present invention may be kept from 0.15% to 0.4% and more preferably from 0.15% to 0.35%.

Aluminum is an element that is present in the steel of the present invention from 0.01% to 0.1%. Aluminum is an alphagenous element and imparts ductility of the steel of the present invention. Aluminum in the steel has a tendency to bond with nitrogen to form aluminum nitride hence from point of view of the present invention the Aluminum content must be kept as low as possible and preferably from 0.02% to 0.06%.

Chromium is an essential element for the present invention. Chromium content is present in the steel of the present invention from 0.3% to 1%. Chromium provides strength and hardening to the steel but when used above 1% it impairs surface finish of steel. The preferred limit for Chromium for the present invention is from 0.35% to 0.9% and more preferably 0.35% to 0.7%.

Molybdenum is an essential element that constitutes 0.1% to 0.5% of the steel of the present invention. Molybdenum increases the hardenability of the steel of the present invention and influences the transformation of austenite to Ferrite and Bainite during cooling after hot rolling. However, the addition of Molybdenum excessively increases the cost of the addition of alloy elements, so for economic reasons its content is limited to 0.5%. Preferable limit for molybdenum is from 0.15% to 0.4% and more preferably from 0.2% to 0.35%.

Vanadium is an essential element that constitutes from 0.05% to 0.14% of the steel of the present invention. Vanadium is effective in enhancing the strength of steel by forming carbides, nitrides or carbo-nitrides and the upper limit is 0.14% due to the economic reasons. These carbides, nitrides or carbo-nitrides are formed during the second and third step of cooling. Preferable limit for Vanadium is from 0.05% to 0.12%.

Phosphorus constituent of the steel of the present invention is from 0.002% to 0.02%. Phosphorus reduces the spot weldability and the hot ductility, particularly due to its tendency to segregate at the grain boundaries or co-segregate with manganese. For these reasons, its content is limited to 0.02% and preferably lower than 0.015%.

Sulfur is not an essential element but may be contained as an impurity in steel and from the point of view of the present invention the Sulfur content is preferably as low as possible, but is 0.005% or less from the viewpoint of manufacturing cost. Further, if a higher Sulfur content is present in steel it combines to form Sulfides especially with Manganese and reduces its beneficial impact on the steel of the present invention, therefore the preferred Sulfur content is below 0.003%

Nitrogen is limited to 0.01% in order to avoid ageing of the material. Nitrogen forms the nitrides which impart strength of the steel of the present invention by precipitation strengthening with Vanadium and Niobium, but whenever the presence of nitrogen is more than 0.01% it can form high amount of Aluminum Nitrides which are detrimental for the present invention hence the preferable upper limit for nitrogen is 0.005%.

Niobium is an optional element for the present invention. Niobium content may be present in the steel of the present invention from 0% to 0.09% and is added in the steel of the present invention for forming carbides or carbo-nitrides to impart strength to the steel of the present invention by precipitation strengthening. A preferable content for the present invention may be kept from 0.02% to 0.07% and more preferably from 0.02% to 0.05%.

Titanium is an optional element which added to the steel of the present invention from 0% to 0.09%, preferably from 0.01% to 0.06%. As niobium, it is involved in the formation of carbides and carbo-nitrides. Therefore it plays a role in hardening and providing strength to the steel. But it is also involved to form TiN appearing during solidification of the cast product. The amount of Ti is limited to 0.09% to avoid coarse TiN detrimental for hole expansion. If the titanium content is below 0.01% it does not impart any effect on the steel of the present invention.

Nickel may be added as an optional element in an amount of 0% to 1% to increase the strength of the steel and to improve its toughness. A minimum of 0.01% is required to produce such effects. However, when its content is above 1%, Nickel causes ductility deterioration.

Copper may be added as an optional element in an amount of 0% to 1% to increase the strength of the steel and to improve its corrosion resistance. A minimum of 0.01% is required to produce such effects. However, when its content is above 1%, copper causes hot ductility deterioration during hot rolling.

Calcium is an optional element which may be added to the steel of the present invention up to 0.005%, preferably from 0.001% to 0.005%. Calcium is added to the steel of the present invention as an optional element especially during the inclusion treatment. Calcium contributes towards the refining of the steel by decreasing the detrimental sulfur content in globularizing it.

Other elements such as cerium, boron, magnesium or zirconium can be added individually or in combination in the following proportions: Ce≤0.1%, B≤0.05%, Mg≤0.05% and Zr≤0.05%. Up to the maximum content levels indicated, these elements make it possible to refine the grain during solidification.

The remainder of the composition of the Steel consists of iron and inevitable impurities resulting from processing.

The microstructure of the Steel sheet comprises:

Bainite constitutes from 50% to 93% of microstructure by area fraction for the steel of the present invention. Bainite constitutes the primary phase of the steel as a matrix and cumulatively consists of Upper Bainite and Lower Bainite. To ensure tensile strength of 770 MPa and preferably 800 MPa or more it is necessary to have 50% of Bainite. Bainite starts forming during the cooling step and forms till the coiling. Preferably, the content of Bainite is from 60% to 92% and more preferably from 70% to 90%.

Ferrite constitutes from 5% to 50% of microstructure by area fraction for the steel of the present invention. Ferrite cumulatively comprises of Polygonal ferrite and acicular ferrite. Ferrite imparts elongation as well as formability to the steel of the present invention. To ensure an elongation of 14% or more it is necessary to have 5% of Ferrite. Ferrite is formed during the cooling after hot rolling in the steel of the present invention. But whenever ferrite content is present above 50% in the steel of the present invention the tensile strength is not achieved. Preferably, the content of Ferrite is from 5% to 30% and more preferably from 5% to 25%.

Martensite-Austenite islands are a constituent for the steel of the present invention from 1% to 15% by area fraction. Martensite-Austenite islands impart strength to the Steel of the present invention. When Martensite-Austenite islands are in excess of 15% it imparts excess strength, and the yield strength goes beyond an acceptable upper limit. In a preferred embodiment Martensite-Austenite islands are from 1% to 12% and more preferably from 1% to 6%.

Pearlite is an essential constituent of the microstructure of the steel of the present invention and present from 1% to 15%. Pearlites impart strength to the steel. Pearlite forms during the cooling after the hot rolling temperature and till the coiling temperature. In a preferred embodiment Pearlite is from 1% to 12% and more preferably from 1% to 8%.

In addition to the above-mentioned microstructure, the microstructure of the hot rolled steel sheet is free from other microstructural components, such as Cementite, but may be found in traces.

A steel sheet according to the invention can be produced by any suitable method. A preferred method consists in providing a semi-finished casting of steel with a chemical composition according to the invention. The casting can be done either into ingots or continuously in form of thin slabs or thin strips, i.e. with a thickness ranging from approximately 220 mm for slabs up to several tens of millimeters for thin strips.

For example, a slab having the above-described chemical composition is manufactured by continuous casting wherein the slab optionally underwent the direct soft reduction during the continuous casting process to avoid central segregation and to ensure a ratio of local Carbon to nominal Carbon kept below 1.10. The slab provided by the continuous casting process can be used directly at a high temperature after the continuous casting or may be first cooled to room temperature and then reheated for hot rolling.

The temperature of the slab, which is subjected to hot rolling, is preferably at least 1200° C. and must be below 1300° C. In case the temperature of the slab is lower than 1200° C., an excessive load is imposed on a rolling mill. Therefore, the temperature of the slab is preferably sufficiently high so that hot rolling can be completed in the in 100% austenitic range. Reheating at temperatures above 1275° C. must be avoided because it causes productivity loss and is also industrially expensive. Therefore, the preferred reheating temperature is from 1200° C. to 1275° C.

Hot rolling finishing temperature for the present invention is from 850° C. to 975° C. and preferably from 880° C. to 930° C.

The hot rolled strip obtained in this manner is then cooled wherein the cooling starts immediately after finishing of the hot rolling and the hot rolled strip is cooled from finishing of the hot rolling to a cooling stop temperature range which is from 480° C. to 600° C. at a cooling rate greater than 20° C./s and preferably the cooling rate from 40° C./s to 150° C./s and more preferably from 40° C./s to 120° C./s. The preferable cooling stop range is from 490° C. to 590° C. and more preferably from 500° C. to 580° C.

Thereafter coiling the hot rolled strip from the coiling temperature range 480° C. and 550° C. and preferably from 490° C. to 540° C. Then cooling the coiled hot rolled strip to room temperature to obtain a hot rolled steel sheet.

The hot rolled steel thus obtained preferably has a thickness from 0.1 mm to 12 mm and more preferably from 0.1 mm to 8 mm and even more preferably from 0.1 mm to 5 mm.

### Examples

The following tests, examples, figurative exemplification and tables which are presented herein are non-restricting in nature and must be considered for purposes of illustration only, and will display the advantageous features of the present invention.

Steel sheets made of steels with different compositions are gathered in Table 1, where the steel sheets are produced according to process parameters as stipulated in Table 2, respectively. Thereafter Table 3 gathers the microstructures of the steel sheets obtained during the trials and table 4 gathers the result of evaluations of obtained properties.

TABLE 1

| Steel | | | | | | | | | | | | | | |
|---|---|---|---|---|---|---|---|---|---|---|---|---|---|---|
| Samples | C | Mn | Si | Al | Cr | Mo | V | S | N | P | Nb | Ti | Ni | Cu |
| I1 | 0.120 | 1.559 | 0.197 | 0.040 | 0.409 | 0.298 | 0.098 | 0.001 | 0.0057 | 0.0107 | 0.0025 | 0.0025 | 0.029 | 0.080 |
| I2 | 0.123 | 1.604 | 0.215 | 0.035 | 0.416 | 0.297 | 0.098 | 0.002 | 0.0059 | 0.0093 | 0.0030 | 0.0036 | 0.035 | 0.087 |
| I3 | 0.131 | 1.600 | 0.197 | 0.037 | 0.403 | 0.287 | 0.087 | 0.002 | 0.0068 | 0.0141 | 0.0021 | 0.0029 | 0.042 | 0.128 |
| R1 | 0.118 | 1.564 | 0.196 | 0.034 | 0.392 | 0.300 | 0.098 | 0.001 | 0.0054 | 0.0095 | 0.0002 | 0.002 | 0.040 | 0.094 |
| R2 | 0.121 | 1.620 | 0.213 | 0.025 | 0.382 | 0.299 | 0.090 | 0.002 | 0.0072 | 0.0106 | 0.0003 | 0.0027 | 0.036 | 0.094 |

I = according to the invention;
R = reference;

TABLE 2
Table 2 gathers the process parameters
implemented on steels of Table 1

| | | HR | Cooling | Cooling | Cooling | |
|---|---|---|---|---|---|---|
| | Reheating | Finish T | start T | rate | stop T | Coiling T |
| Trials | T (° C.) | (° C.) | (° C.) | (° C./s) | (° C.) | (° C.) |
| I1 | 1230 | 925 | 925 | 80 | 575 | 575 |
| I2 | 1230 | 930 | 930 | 80 | 550 | 550 |
| I3 | 1230 | 920 | 920 | 80 | 510 | 510 |
| R1 | 1230 | 925 | 925 | 80 | 630 | 630 |
| R2 | 1230 | 925 | 925 | 80 | 430 | 430 |

I = according to the invention;
R = reference; underlined values: not according to the invention

Table 3: Table 3 exemplifies the results of the observation of the microstructure wherein the microstructure was observed with SEM after 2% Nital etching. The volume fractures of phases were measured by systematic manual point count method according to ASTM E562 of both the inventive and reference steels.

The results are stipulated herein:

| Steel | | | Martensite- | |
|---|---|---|---|---|
| Sample | Ferrite | Bainite | Austenite Islands | Pearlite |
| I1 | 18 | 73 | 3 | 6 |
| I2 | 16 | 76 | 4 | 4 |
| I3 | 6 | 89 | 3 | 2 |
| R2 | 70 | 11 | 3 | 16 |
| R3 | 0 | 90 | 10 | 0 |

I = according to the invention;
R = reference; underlined values: not according to the invention.

### Table 4

Table 4 exemplifies the mechanical properties of both the inventive steel and reference steels. In order to determine the tensile strength, yield strength and total elongation, tensile tests are conducted in accordance with JIS Z2241 standards and the hole expansion ratio is measured in accordance of ISO16630 standards.

The results of the various mechanical tests conducted in accordance with the standards are gathered

TABLE 4

| | LONGITUDNAL | | | TRANSVERSAL | | | |
|---|---|---|---|---|---|---|---|
| | DIRECTION | | | DIRECTION | | | |
| Sample | UTS | YS | TE | UTS | YS | TE | |
| Steels | (MPa) | (MPa) | (%) | (MPa) | (MPa) | (%) | HER (%) |
| I1 | 830 | 679 | 18 | 845 | 727 | 17 | 65 |
| I2 | 829 | 689 | 18 | 842 | 736 | 16 | 64 |
| I3 | 892 | 764 | 15 | 889 | 803 | 15 | 66 |
| R1 | 740 | 577 | 22 | 750 | 627 | 20 | 65 |
| R2 | 925 | 890 | 7 | 960 | 930 | 6 | 60 |

I = according to the invention;
R = reference; underlined values: not according to the invention.

What is claimed is:

1-15. (canceled)

16: A hot rolled steel sheet having a composition comprising the following elements, expressed in percentage by weight:
$$0.09 \% \leq Carbon \leq 0.15 \%$$
$$1 \% \leq Manganese \leq 2 \%$$
$$0.1 \% \leq Silicon \leq 0.5 \%$$
$$0.01 \% \leq Aluminum \leq 0.1 \%$$
$$0.3 \% \leq Chromium \leq 1 \%$$
$$0.1 \% \leq Molybdenum \leq 0.5 \%$$
$$0.05 \% \leq Vanadium \leq 0.14 \%$$
$$0.002 \% \leq Phosphorus \leq 0.02 \%$$
$$0 \% \leq Sulfer \leq 0.005 \% .$$
$$0 \% \leq Nitrogen \leq 0.01 \%$$
and optionally one or more of the following elements
$$0 \% \leq Niobium \leq 0.09 \%$$
$$0 \% \leq Titanium \leq 0.09 \%$$
$$0 \% \leq Calcium \leq 0.005 \%$$
$$0 \% \leq Copper \leq 1 \%$$
$$0 \% \leq Nickel \leq 1 \%$$
$$0 \% \leq Boron \leq 0.05 \%$$
$$0 \% \leq Magnesium \leq 0.05 \%$$
$$0 \% \leq Zirconium \leq 0.05 \%$$
$$0 \% \leq Cerium \leq 0.1 \%$$
a remainder of the composition being composed of iron and unavoidable impurities caused by processing,
a microstructure of the steel sheet comprising in area fraction, 50% to 93% of Bainite, 5% to 50% of ferrite, 1% to 15% of Martensite-Austenite islands, 1% to 15% Pearlite.

17: The hot rolled steel sheet as recited in claim 16 wherein the composition includes 0.15% to 0.4% of Silicon.

18: The hot rolled steel sheet as recited in claim 16 wherein the composition includes 0.1% to 0.14% of Carbon.

19: The hot rolled steel sheet as recited in claim 18 wherein the composition includes 0.05% to 0.12% of Vanadium.

20: The hot rolled steel sheet as recited in claim 16 wherein the composition includes 1.3% to 1.9% of Manganese.

21: The hot rolled steel sheet as recited in claim 16 wherein the composition includes 0.35% to 0.9% of Chromium.

22: The hot rolled steel sheet as recited in claim 16 wherein the amount of pearlite is from 1% to 12% in area fraction.

23: The hot rolled steel sheet as recited in claim 16 wherein the steel sheet has a yield strength equal to or greater than 650 MPa in both a transverse direction and a longitudinal direction.

24: The hot rolled steel sheet as recited in claim 16 wherein said steel sheet has a tensile strength equal to or greater than 770 MPa in both a transverse direction and a longitudinal direction.

25: A method of production of a hot rolled steel sheet comprising the following successive steps:
providing a semi-finished product have a composition comprising the following elements, expressed in percentage by weight:
$$0.09 \% \leq Carbon \leq 0.15 \%$$
$$1 \% \leq Manganese \leq 2 \%$$
$$0.1 \% \leq Silicon \leq 0.5 \%$$
$$0.01 \% \leq Aluminum \leq 0.1 \%$$
$$0.3 \% \leq Chromium \leq 1 \%$$
$$0.1 \% \leq Molybdenum \leq 0.5 \%$$
$$0.05 \% \leq Vanadium \leq 0.14 \%$$
$$0.002 \% \leq Phosphorus \leq 0.02 \%$$
$$0 \% \leq Sulfer \leq 0.005 \% .$$
$$0 \% \leq Nitrogen \leq 0.01 \%$$
and optionally one or more of the following elements
$$0 \% \leq Niobium \leq 0.09 \%$$
$$0 \% \leq Titanium \leq 0.09 \%$$
$$0 \% \leq Calcium \leq 0.005 \%$$
$$0 \% \leq Copper \leq 1 \%$$
$$0 \% \leq Nickel \leq 1 \%$$
$$0 \% \leq Boron \leq 0.05 \%$$
$$0 \% \leq Magnesium \leq 0.05 \%$$
$$0 \% \leq Zirconium \leq 0.05 \%$$
$$0 \% \leq Cerium \leq 0.1 \%$$
a remainder of the composition being composed of iron and unavoidable impurities caused by processing;
reheating the semi-finished product to a temperature from 1200° C. to 1300° C.;
hot rolling the semi-finished product in the austenitic range wherein a finishing temperature of the hot rolling is from 850° C. to 975° C. to obtain a hot rolled steel strip;
then cooling the hot rolled strip wherein the cooling starts immediately after the finishing of hot rolling, the hot rolled strip being cooled from the finishing of the hot rolling to a cooling stop temperature range from 480° C. to 600° C. at a cooling rate greater than 20° C./s;
thereafter coiling the hot rolled strip at the coiling temperature range 480° C. to 600° C.; and
then cooling the coiled hot rolled strip to room temperature to obtain a hot rolled steel sheet.

26: The method as recited in claim 25 wherein the reheating temperature for the semi-finished product is from 1200° C. to 1275° C.

27: The method as recited in claim 25 wherein the finishing temperature is from 880° C. to 930° C.

28: The method as recited in claim 25 wherein the cooling rate from the finishing of the hot rolling to the cooling stop temperature is from 40° C./s to 120° C./s.

29: A method for the manufacture of structural or safety parts of a vehicle comprising employing a steel sheet produced according to the method of claim.

30: A vehicle comprising a part obtained according to the method of claim 29.

31: A method for the manufacture of structural or safety parts of a vehicle comprising employing hot rolled steel sheet as recited in claim 16.

32: A vehicle comprising a part obtained according to the method of claim 31.
